(19) United States
(12) Patent Application Publication
(10) Pub. No.: US 2010/0024233 A1
(43) Pub. Date: Feb. 4, 2010

(54) PROBE EMULATION AND SPATIAL PROPERTY MEASUREMENT IN MACHINE TOOLS

(75) Inventors: Patrick Gerard Boland, Victoria (AU); David Fisher, Victoria (AU)

Correspondence Address: SHERIDAN ROSS PC, 1560 BROADWAY, SUITE 1200, DENVER, CO, 80202, US

(73) Assignee: ANCA PTY LTD, Victoria (AU)

(21) Appl. No.: 12/302,520

(22) PCT Filed: Jul. 3, 2007
(86) PCT No.: PCT/AU2007/000919

§ 371 Date: Apr. 8, 2009

(30) Foreign Application Priority Data
Jul. 3, 2006 (AU) 2006903576

(51) Int. Cl. B24B 49/02; B23Q 15/22; B23Q 17/22

(52) U.S. Cl. 33/628; 318/627

(57) ABSTRACT

A method of sensing contact between a first member (606, 908) and a second (608, 910) member in a computer numerical control machine, wherein the position of at least one of the first member and the second member is controlled by one or more servo mechanisms, the method including the steps of: causing at least one of the first member and the second member to be driven towards the other; monitoring an error signal in one of the servo mechanisms; and detecting when the error signal exceeds a predetermined threshold.

### FIELD OF THE INVENTION

The present invention relates generally to machine tools, and more particularly to the measurement of position, dimensions, orientation and other spatial properties of various elements of the machine tool and associated workpieces. The present invention has particular application in the measurement of spatial properties of a grinding wheel in a computer numerically controlled grinding machine, and it will be convenient to describe the invention in relation to that exemplary application. It is to be understood however that the invention is not limited to that application only.

### BACKGROUND OF THE INVENTION

Modern computer numerically controlled (CNC) machine tools are capable of machining complex parts to micron level tolerances. To produce parts of this accuracy, it is necessary to know the exact dimensions of the cutting tool or grinding wheel, as well as the workpiece.

The use of high precision electrical contact probes has become widespread in the machine tool industry for the measurement of workpiece dimensions and orientation. Typically the probe is mounted to the machine tool and produces a binary contact signal when a certain deflection occurs. The probe is then allowed to overtravel in the order of 10 mm to allow the machine tool axes to decelerate to a stop. Several methods of sensing the mechanical deflection are used in different types of probes. Known methods includes the closing of an electrical circuit, breaking a switch, breaking a laser beam and using a strain gauge type force sensor in the probe.

Electrical probe technology works quite well but has the following disadvantages. Firstly, probes of this type are relatively expensive because of the requirement for high position and environmental robustness. Secondly, probes of this type require electrical connection with the control unit of the machine tool in order to transfer the contact signal. This is a major disadvantage when the probe has to be removed from the machine tool during machining operations.

Moreover, current probe technologies are unsuitable for use in a number of applications in which the spatial properties of machine tool elements are required to be measured. For example, in a CNC grinding machine, it is necessary to know the exact dimensions of the grinding wheel in order that the workpiece can be machined to the same or better levels of accuracy. However, the measurement of the dimensions of the grinding wheel is complicated by several factors. Firstly, the surface of a grinding wheel is very rough. The real surface acting to machine the workpiece is the envelop of all protruding abrasive grains as the wheel rotates. Secondly, the dimensions of a wheel change due to centrifugal forces due to its rotation. It is possible to measure grinding wheels externally using computer vision techniques, but this technique is costly and introduces additional errors due to the mismatch of wheel references between the grinding machine and the measuring machine.

It is also important to measure the wheel profile (i.e. toroid radius) of the grinding wheel. This is the blend surface between two conical sections of the grinding wheel and between a cylindrical section and a conical section. Typically this section of the grinding wheel does most of the final surface grinding. It is very probable that this section will not be an exact toroid but will be an undefined blend curve. It is possible to measure the dimensions and spatial properties of grinding wheels and machine tools by using a laser, but this technique is both expensive and time consuming.

Accordingly, there exists a need to provide a method of measuring one or more spatial properties of a machine tool element that is robust, simple to implement, inexpensive and rapid. There also exists a need to provide a method of measuring one or more spatial properties of a machine tool element that ameliorates or overcomes one or more disadvantages of known spatial property measurement methods.

### SUMMARY OF THE INVENTION

One aspect of the invention provides a method of sensing contact between a first member and a second member in a computer numerical control machine, wherein the position of at least one of the first member and the second member is controlled by one or more servo mechanisms, the method including the steps of:

causing at least one of the first member and the second member to be driven towards the other;

monitoring an error signal in one of the servo mechanisms; and

detecting when the error signal exceeds a predetermined threshold.

In a method including these features, a high precision contact probe is emulated by detecting an error signal in one of the servo mechanisms within the computer numerical control machine, thereby eliminating need for a separate contact probe.

In one embodiment of the invention, the error signal is representative of the position error in one of the servo mechanisms.

The computer numerical control machine may include a first group of one or more servo mechanisms that drive at least one of the first member and the second member towards the other; and a second group of one or more other servo mechanisms, wherein the error signal is detected in the second group of servo mechanisms.

One of the first group of servo mechanisms may drive one of the first member and the second member in a circular arc motion. One of the first group of servo mechanisms may alternately or also drive one of the first member and the second member in a linear motion.

The method may further include limiting the directional torque of a servo amplifier forming part of one of the servo mechanisms. The directional torque may be limited by setting a servo amplifier direction or current limit.

In one or more embodiments of the invention, the second member may be any one of a workpiece, a grinding wheel or a cutting tool. Similarly, the first member may be a mechanical probe.

Another aspect of the invention provides a method of determining one or more dimensions of a working member in a computer numerical control machine, the method including the steps of:

sensing contact between the first member and the second member, according to the above described method, at two or more locations on the second member;

capturing first member position data at each location; and

deriving one or more dimensions of the second member from the captured first member position data.

In a method including these steps, the error signal in one or more servo mechanisms forming part of the computer numerical control machine can be used to measure the dimensions of a working member, such as a grinding wheel or cutting tool, or a workpiece, in the computer numerical control machine.

In one embodiment of the invention, the first member position data is captured from a feedback mechanism forming part of the one or more servo mechanisms.

Another aspect of the invention provides a method of determining the profile of a second member in a computer numerical control machine, the method including the steps of:

sensing contact between the first member and the second member, according to the above described method, two or more locations on a surface of the working member;

capturing first member position data at each location; and

interpolating between the captured first member position data to determine the surface profile of the second member.

In a method including these features, it is possible to use the error signal in one of the servo mechanisms forming part of the computer numerical control machine to capture positional information along the surface profile of a working member, such as a grinding wheel or cutting tool, or workpiece, and interpolate between the positional information to determine the surface profile of that working member.

In one embodiment of the invention, the first member position data is captured from a feedback mechanism forming part of the one or more servo mechanisms.

Another aspect of the invention provides a method of determining the profile of a surface of a second member in a computer numerical control machine, the method including the steps of:

sensing contact between a first member and a second member, according to the above described method, at a first location on the second member;

causing movement of the first member along a first trajectory across the second member surface;

capturing first member position data during movement of the first member across the second member surface;

capturing surface profile data from the error signal in the servo mechanism; and

determining the second member surface profile from the captured first member position date and surface profile date.

In a method including these steps, it is possible to use the error signal in the servo mechanism as a mechanical probe or other machine tool element is caused to move along a first trajectory across the surface of a working member, such as a grinding wheel or cutting tool, or workpiece, to measure the surface profile of that working member.

In one embodiment of the invention, prior to capturing first member position data and surface profile data, the method may further include the step of causing the servo mechanism to over travel by a preloaded amount after contact is sensed between the first member and the second member.

Another aspect of the present invention provides a multi-axis computer numerical control machine including one or more servo mechanisms for controlling the position of at least one of a first member and a second member; and

a numerical control apparatus for controlling operation of the servo mechanisms, the numerical control apparatus and the servo mechanisms including one or control logic elements for performing the above described method.

The control logic elements may include at least one processing unit and associated memory device for storing a series of instructions to cause the processing unit to perform one or more steps of the above described method. The control logic elements may include one or more digital signal processing element. The control logic elements may include one or more hardware elements.

Another aspect of the invention provides a multi-axis computer numerical control grinding machine including one or more servo mechanisms for controlling the position of at least one of a first member and a second member, the second member being a grinding wheel; and numerical control apparatus for controlling operation of the servo mechanisms, the numerical control apparatus and the servo mechanisms including one or more control logic elements for performing the above described method.

### BRIEF DESCRIPTION OF THE DRAWINGS

Preferred embodiments of the present invention will now be described by way of non-limiting examples only with reference to the accompanying drawings in which:

FIG. 1 is a schematic perspective diagram of a number of principal components of a CNC grinding machine;

FIGS. 2 to 4 are schematic diagram of the servo mechanisms and control systems for three different types of servo motors adapted to drive the machine components in FIG. 1;

FIG. 5 is a schematic diagram of a servo loop illustrating the control functionality of the servo mechanisms of FIGS. 2 to 4;

FIG. 6 is a schematic side view of a grinding wheel and chuck assembly of the grinding machine shown in FIG. 1, together with a mechanical probe held in the chuck assembly;

FIG. 7 is a flow chart showing steps involved in using the arrangement shown in FIG. 6 and the machine of FIG. 1 to emulate the operation of an electrical probe;

FIG. 8 is a flow chart showing steps involved in using arrangement shown in FIG. 6 and the machine of FIG. 1 to measure the dimensions of a machine element;

FIG. 9 is a schematic side view of a grinding wheel and chuck assembly of the grinding machine shown in FIG. 1, together with a mechanical probe held in the chuck assembly, in which the profile of the grinding wheel can be seen;

FIG. 10 is a flow chart showing steps involved in a first embodiment for using the arrangement shown in FIG. 6 and the machine of FIG. 1 to measure the profile of the grinding wheel;

FIG. 11 is a flow chart showing steps involved in a second embodiment for using the arrangement shown in FIG. 6 and the machine of FIG. 1 to measure the profile of the grinding wheel; and

FIG. 12 is a flow chart showing a false trigger rejection algorithm used to minimize erroneous contact detections being made during electrical probe emulation.

### DETAILED DESCRIPTION OF THE EMBODIMENTS

The preferred embodiment of the invention will be described in relation to applications involving a five axis CNC grinding machine. It should be noted however that the invention is not limited to this exemplary application and should be considered to be applicable to probe emulation and spatial property measurement of grinding wheels, cutting tools, workpieces or other elements of machine tools.

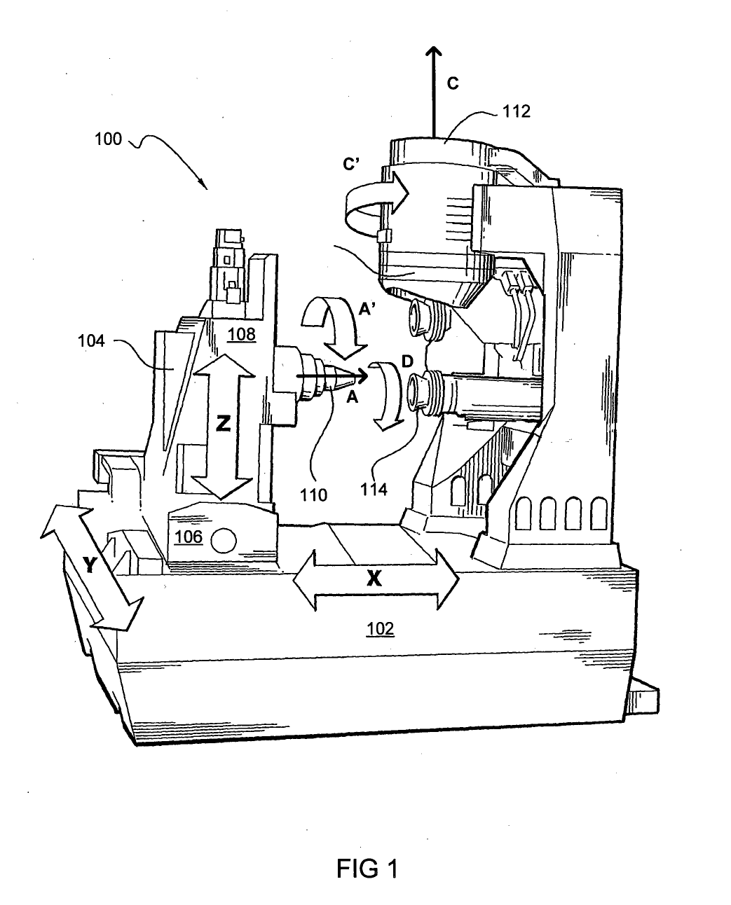

Referring now to FIG. 1, there is shown generally a schematic representation of a five axis CNC grinding machine 100. A head stock assembly 104 is mounted at a first end of the base 102. The head stock assembly 104 includes a saddle 106 which is movable on the base 102 along an X axis. A vertical head stock slide assembly 108 is mounted on the saddle 106 along the Y axis. A chuck assembly 110 is mounted on the vertical slide assembly 108 for movement along a Z axis. As can be seen in FIG. 1, the X, Y and Z axes are orthogonal to each other.

The chuck assembly 110 is coupled to a rotary servo motor and spindle (not shown) so that a workpiece mounted in the jaws of the chuck assembly 110 is rotatable in a direction A′ about the A axis.

A turret arrangement 112 is also mounted on the base 102. A grinding wheel 114 is mounted to the turret assembly 112 by means of a rotary servo motor and spindle (not shown) to enable the grinding wheel to be driven in a circular motion. A further rotary servo motor (not shown) acts to position the grinding wheel 114 by causing movement of the grinding wheel in a direction C′ about the C axis of the grinding machine. The C axis is parallel to the Z axis and orthogonal to the X and Y axes.

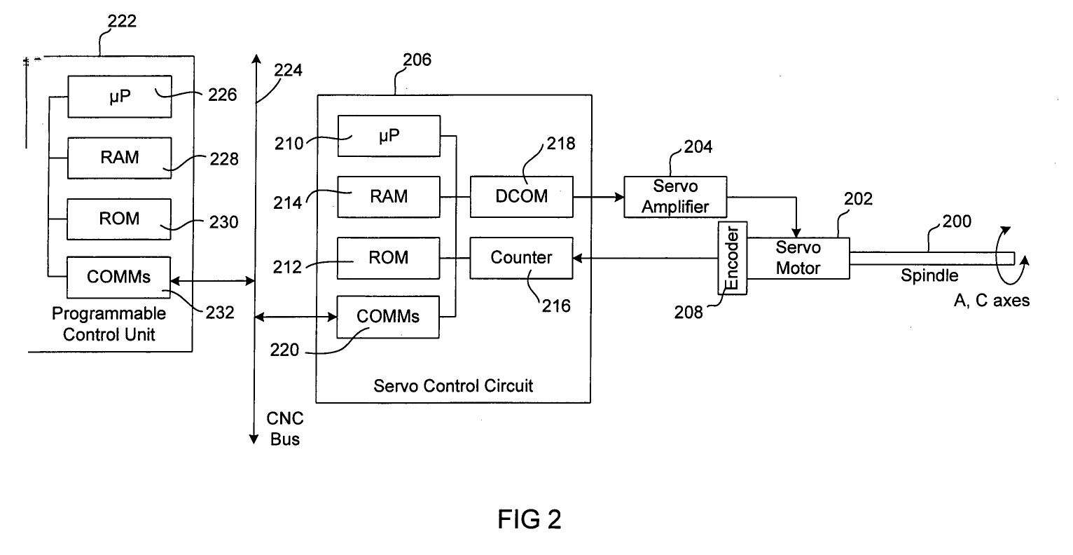

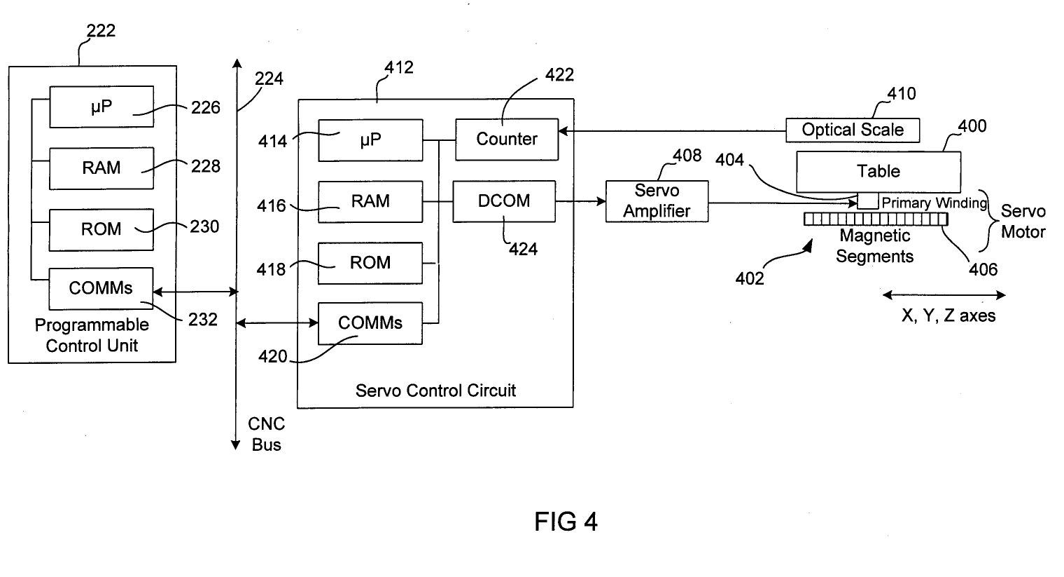

In operation, the workpiece maintained in the jaws of the chuck assembly 110 is positioned with respect to the grinding wheel 114 by driving the saddle, vertical slide assembly 110 and chuck assembly 110 along the X, Y and Z axes, and by causing rotation of the workpiece and the grinding wheel 114 about the A and C axes. The relative orientation and position of the workpiece and the grinding wheel are moved in accordance with a CNC machine in program to cause the workpiece to be ground into a desired shape. Elements of the control and operation of the CNC grinding machine 100 will be explained with reference to FIGS. 2 to 5.

In one embodiment of the invention, the workpiece and grinding wheel are driven in a circular arc motion about the A and C axes by an arrangement shown in FIG. 2. In this arrangement, a spindle 200 is driven about the A and C axes by a rotary servo motor 202. The rotary servo motor 202 is controlled by current provided from a servo amplifier 204, which is in turn controlled by a servo control circuit 206. The servo motor 202 is fitted with an encoder 208 to provide a position feedback signal indicative of the angular spindle position to the servo control circuit 206. Typically, the encoder 208 provides measurement accuracy of approximately 0.0001° in the case of rotary servo motors, and 0.0001 mm in the case of linear servo motors.

The servo control circuit 206 controls the position and speed of the servo motor 202. The servo control circuit 206 includes a microprocessor 210, a non-volatile memory 212 for storing a series of instructions for causing a series of instructions to cause the microprocessor 210 to perform desired control functionality. The servo control circuit 206 further includes a volatile memory 214 for storing data generating during operation of the servo motor 202, a counter 216 for receiving pulsed signals from the encoder 208 indicative of the angular position of the spindle 200, a digital communication link 218 for sending control signals to control operation of the servo amplifier 214, and a communications module 220. The communications module 220 facilitates communication of the servo control circuit 206 with a programmable control unit 222 via a communications bus 224. Each of the movable axes A, C, X, Y and Z are each associated with a separate servo motor and servo control circuit. These servo control circuits all communicate with the programmable control circuit 222 via the communications bus 224.

The programmable control unit 222 includes a microprocessor 226, a volatile memory 228 for storing data produced during operation of the sensor grinding machine 100, and non-volatile memory 230 for storing a series of instructions for controlling operation of the microprocessor 226 and a communications module 232 to enable the programmable control unit 222 to communicate to the communications bus 224.

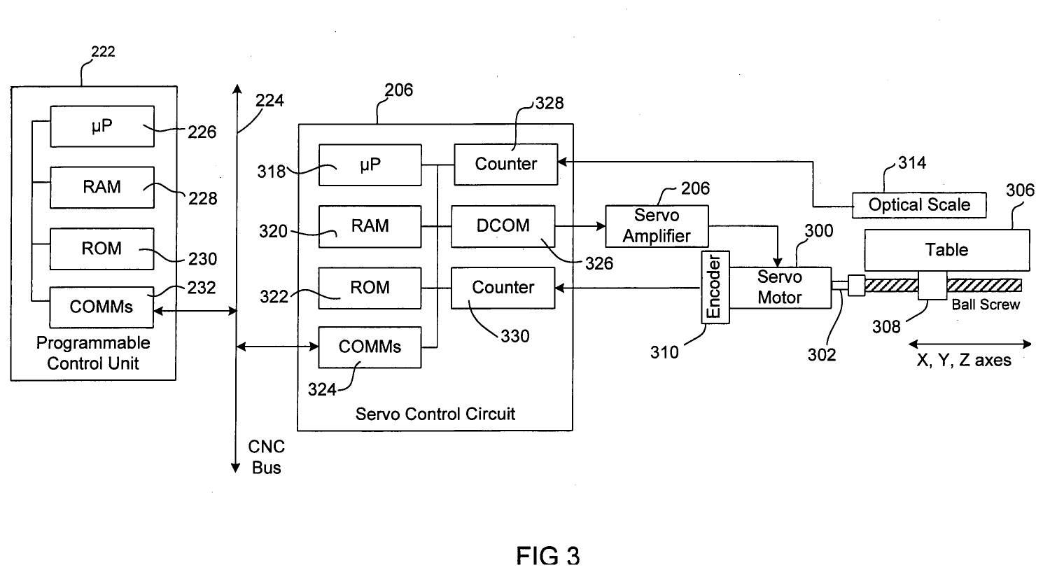

FIG. 3 shows one example of a servo mechanism for controlling movement of components of the CNC grinding machine 200 that are driven along the X, Y and Z axes. As shown in FIG. 3, a servo motor 300 drives a spindle 302 which is in turn connected to a ball screw 304. Operation of the servo motor 300 causes rotation of the ball screw 300 about its longitudinal axis. A table 306 or other movable component is coupled to the ball screw 304 by means of a threaded coupling 308 so that the rotational movement of the ball screw 304 is translated into linear movement of the table 306 along the X, Y or Z axes. Once again, an encoder 310 is coupled to the servo motor 300 and provides a series of pulses to the servo control circuit 312 to enable a determination of the angular position of the spindle 302. In addition, an optical scale 314 converts linear movement of the table 306 in the X, Y or Z axes into pulses to enable the servo control circuit 312 to determine the linear position of the table 306. The servo motor 300 is controlled by signals from a servo amplifier 316, which is in turn controlled by the servo control circuit 312.

The servo control circuit 312 includes a microprocessor 318, a non-volatile memory 320, a volatile memory 322, a communications module 324 for enabling the servo control circuit 312 to communicate with the programmable control unit 222 via the communications bus 224. The servo control circuit 312 also includes a digital communications link 326 to enable digital control signals to be transferred to the servo amplifier 316. The servo control circuit 312 further includes counters 328 and 330 respectively coupled to the optical scale 314 and encoder 310.

In an alternate embodiment, linear movement of the table 400 is caused by operation of a linear servo motor 402 including a primary winding 404 coupled to table and a series of magnetic segments 406. A servo amplifier 408 acts to control the plurality of the magnetic segments 406 and thereby cause linear movement of the table 400 along the X, Y or Z axes. An optical scale 410 converts the linear movement of the table 400 into a series of pulses transmitted to a servo control circuit 412. The servo control circuit 412 includes a microprocessor 414, a volatile memory 416, a non-volatile memory 418, and a communications module 420 for enabling communication of a servo control circuit 412 with the programmable control unit 222 via the communications bus 224. The servo control circuit also includes a counter 422 for counting pulses received from the optical scale 410 and a digital communications link 424 for controlling operation of the servo amplifier 408.

It will be appreciated that the programmable control unit 222 is but one example of a control apparatus for controlling and coordinating operation of the servo mechanisms shown in FIGS. 2 to 4. The programmable control unit and the servo mechanisms include a number of control logic elements that can be implemented in a number of ways. In the exemplary embodiments shown in FIGS. 2 to 4, the control logic elements include at least one processing unit and associated memory device for storing a series of instructions to cause the processing unit to perform a desired series of operations. Alternately, the control logic elements could include one of more digital signal processing elements and/or one or more hardware elements.

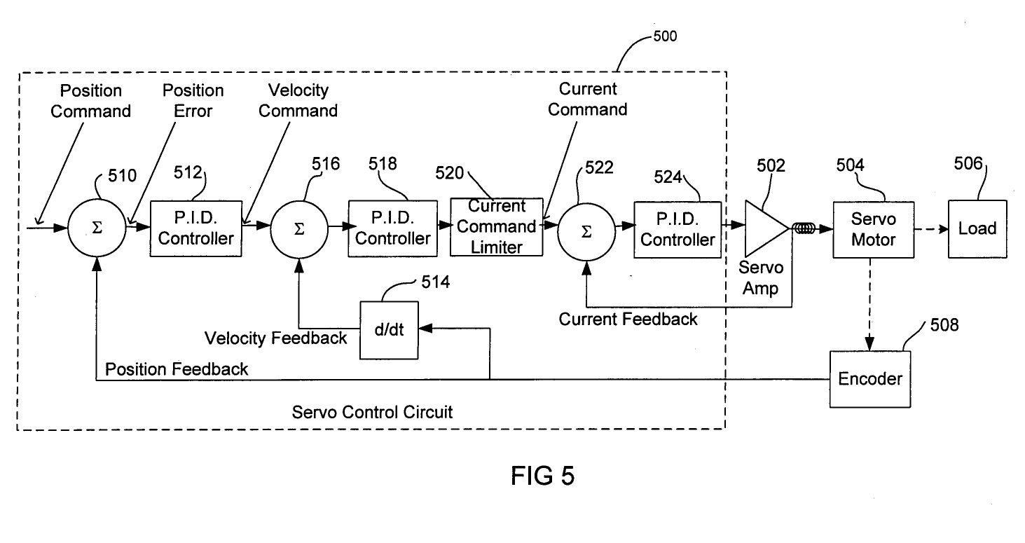

Each of the control circuits 206, 312 and 412 operate in accordance with the servo loop diagram shown in FIG. 5. This diagram shows an exemplary servo control circuit 500 used to command a servo amplifier 502 and thereby control operation of a servo motor 504 driving a load 506. An encoder 508 provides position feedback information to the servo control circuit 500. The servo control circuit 500, and the servo control circuits 206, 312 and 412, receives a position command signal from the programmable control unit 222 to drive the grinding machine component to a desired angular or linear position.

The difference between the position command signal and the position feedback signal provided by the encoder 508 is determined by a summation block 510 which results in the generation of a position error. That position error is provided to a proportional-integral-derivative (PID) controller 512. The output of the PID controller 512 is a velocity command signal. A time based derivative of the position feedback signal provided by the encoder 508 is determined by a derivative block 514. The output of the derivative block 514 is provided to a summation device 516 and combined with the velocity command signal at the output of the PID controller 512. The difference between the velocity command signal and the velocity feedback signal is provided as an input to a PID controller 518. The output of the PID controller 518 generates a current command signal for driving the servo amplifier 502. However, a current command limiter 520 acts to limit the current command signal provided to the servo amplifier 502 to thereby limit the directional torque of the servo motor 504. The difference between the limited command signal and a current feedback signal from the output of the servo amplifier 502 is determined by a summation device 522. The output of the summation device 522 is provided as an input to a PID controller 524, which provides a drive signal to the servo amplifier 502.

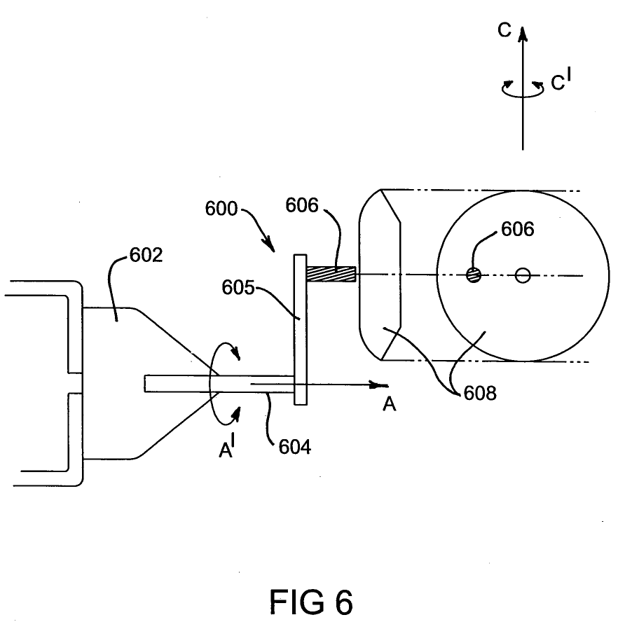

In such an arrangement, it is possible to sense contact between two members of the CNC grinding machine 200 by causing at least one of the two members to be driven towards the other, and then monitoring an error signal in one of the servo mechanisms. Contact is detected when the error signal exceeds a predetermined threshold. In the exemplary embodiment shown in FIG. 6, a rigid mechanical probe 600 is mounted within the jaws of a chuck 602. The rigid mechanical probe 600 includes a first arm 604 extending along the A axis when mounted in the chuck 602, a laterally projecting member 605 and a second arm 606 projecting from the member 605 to enable contact to be made by the mechanical probe 600 on the grinding wheel 608 at a position laterally offset from the A axis. In order to minimise wear, a diamond pad or like protective element can be applied to one of the grinding wheel or the probe in a zone where contact will be made.

In order to emulate the functioning of a conventional electrical probe, the grinding wheel 608 is brought into contact with the rigid mechanical probe 600 by causing operation of at least one of the servo mechanisms on the A, C, X, Y or Z axes. Conveniently, rotation of the grinding wheel about the C axis and rotation of the rigid mechanical probe 600 about the A axis is prevented, whilst the rigid mechanical probe 600 is moved along the X, Y and/or Z axes until contact is made with the grinding wheel 608. Deflection on the A or C axes at the instant of contact is determined in this example by monitoring the position error in the servo control circuit 206 driving the servo motor 202 on those axes, and more particularly detecting when the position error exceeds a predetermined threshold.

In this example, a first group of one or more servo mechanisms are used to drive at least one grinding machine member towards another, and the error signal in a second group of one or more other servo mechanisms on axes that remain stationary whilst contact is obtained, is used to provide an indication of axis deflection and hence contact between the two members. In this case the second group of servo mechanisms are the A and C axes servo mechanisms (normally used to drive the grinding wheel 608 and the rigid mechanical probes 600 in a circular arc motion), and the first group of servo mechanisms are the X, Y and Z axes servo mechanisms used to drive the rigid mechanical probe 600 along linear axes. However, in other embodiments of the invention, different combinations of servo mechanisms may be used to drive members of the grinding machine 100 together and to monitor the position or other error signal in a servo control circuit to provide an indication of contact between the members.

It will also be appreciated that whilst a rigid mechanical probe 600 has been used in the example shown in FIG. 6, in other embodiments of the invention contact between any two members of the CNC grinding machine 100 may be detected by this method, regardless of whether those members are separately attached to the CNC grinding machine 100 or form part of conventional elements of the grinding machine. For example it is possible to use this method to detect contact between the chuck 602 and grinding wheel 608 without use of the rigid mechanical probe 600.

When the rigid mechanical probe 600 is driven along the X, Y and/or Z axes, a directional torque limit is set in the servo mechanism of the relevant axis or axes. The torque limit is set by means of the current command limit of block 520 in the servo control circuit 500 to effectively limit the current applied to the servo amplifier 502 and the servo motor 504. Limiting the torque limit ensures that contact is made between the probe 600 and the grinding wheel 608 with very little force so that little deformation of either the probe or other machine components is caused.

Moreover, the load torque limit means that the C or A axis deflection is quickly detected and the response time of the grinding machine control system is minimised. Detecting when the position error exceeds a predetermined limit emulates the electrical signal generated by a typical electrical probe, such as a renishaw probe. The emulate probe signal is used by the programmable control unit and the servo control units of the grinding machine 100 in exactly the same way as the probe signal of a conventional electrical probe would be.

In one or more embodiments, the servo mechanisms on those axes intended to remain stationary during probe emulation remain operative. That is, the servo loop shown in FIG. 5 seeks to actively maintain the axes in a fixed orientation or position. However, in other embodiments, the seal friction between mechanical components on one or more axes is sufficient for those axes to remain stationary during probe emulation. In this case, the servo drive on those axes can be disactivated.

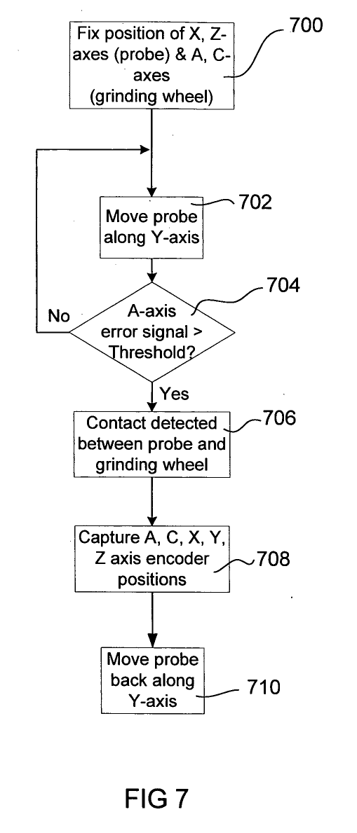

FIG. 7 shows an example of the steps involved in this probe emulation process. At step 700, the positions of the X, Z, A and C axes are fixed, and at step 702, the probe is driven along the Y axis. When it is detected at step 704 that the A axis error signal has exceeded a predetermined threshold, then contact between the probe and grinding wheel is identified at step 706. The encoder positions of the A, C, X, Y and Z axes are then captured at step 708 and transmitted from each servo control circuit to the programmable control unit 222 in the grinding machine 100. A three dimensional reference point indicative of the contact between the rigid mechanical probe and grinding wheel, or other two grinding machine elements, is therefore available to the grinding machine. In order to minimise contact time, once the encoder positions of the A, C, X, Y and Z axes have been captured, the probe is driven back along the Y-axis in the opposite direction at step 710.

The same general principle can be applied to determine one or more dimensions of a working member, such as a grinding wheel or cutting tool, or a workpiece that is shaped or cut by a grinding wheel or cutting tool, in which contact is sensed between a first member and a working member at two or more locations on the working member, and data indicative of the three dimensional position of the first member is captured at each location. The dimensions of the working member can then be derived from the captured first member position data.

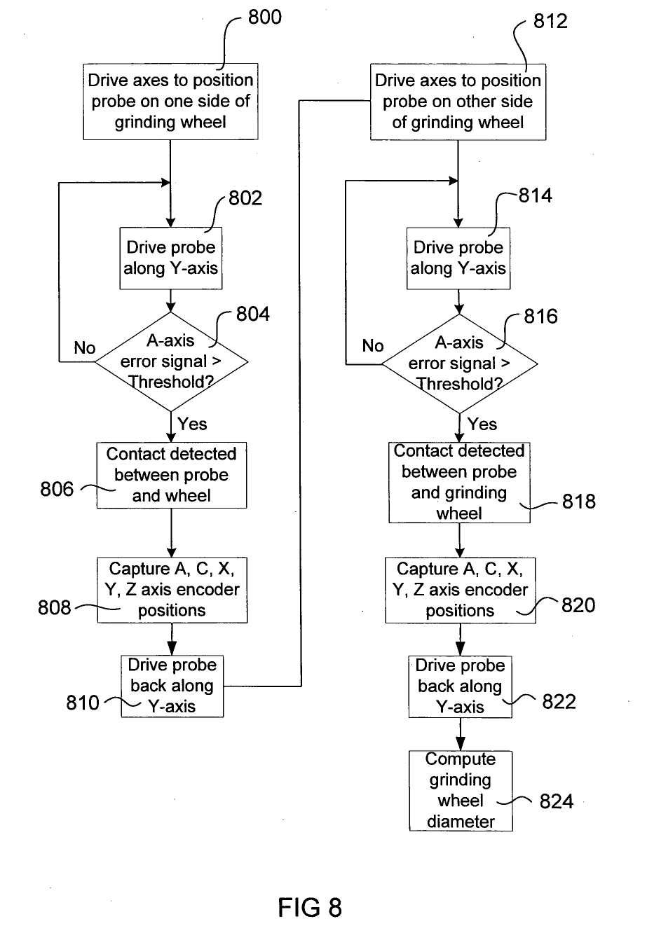

An example of this method is illustrated in FIG. 8 in this figure, at step 800 the A, C, X, Y and/or Z axes are driven to position the probe 600 to one side of the grinding wheel 608. At step 802, the probe is driven along the Y axis until the A axis position error signal is detected to have exceeded a predetermined threshold at step 804. Contact is accordingly determined to have been made between the probe 600 and the grinding wheel 608 at step 806 and axial position information from the encoders or optical scales associated with each of the A, C, X, Y and Z axes are captured at step 808. Once the encoder positions of the A, C, X, Y and Z axes have been captured, the probe is driven back along the Y-axis in the opposite direction at step 810 to break contact between the probe and the grinding wheel. This axial position information is then sent from each servo control circuit to the programmable control unit 222 via the communications bus 224.

At step 812, the A, C, X, Y and/or Z axes are driven to position the probe 600 on the other side of the grinding wheel 608. Once again, the probe 600 is driven in step 814 along the Y axis until the A axis error signal is determined at step 816 to have exceeded a predetermined threshold. At step 818, contact is determined to have been made between the probe 600 and the grinding wheel 608 and axial position information from the A, C, X, Y and Z axes captured at step 820. Once the encoder positions of the A, C, X, Y and Z axes have been captured, the probe is again driven back along the Y-axis in the opposite direction at step 822 to break contact between the probe and the grinding wheel. The captured axial position information is then transmitted to the programmable control unit 222, and at step 824 a comparison made between the axial position information captured at step 810 and the axial position information captured at 820 in order to determine the diameter of the grinding wheel 608.

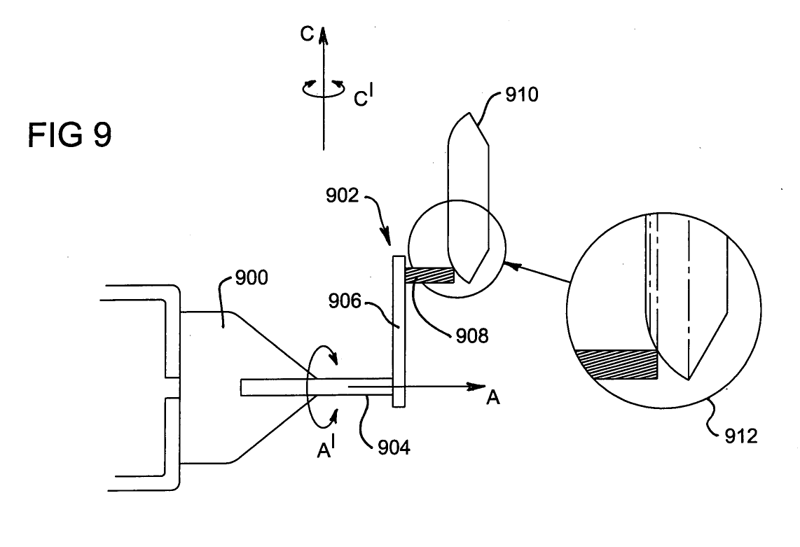

It will be appreciated that other dimensions of the grinding wheel or any other working member of the grinding machine 100 may be measured according to this technique. The arrangements shown in FIGS. 2 to 5 are also suitable for use in determining the profile of a member of the grinding machine 100. In particular, the profile of the grinding wheel can be determined to a high degree of precision. FIG. 9 shows an example of a chuck assembly 900 and mechanical probe 902. The mechanical probe 902 includes a first arm 904 extending along the A axis when mounted in the chuck 900, a laterally projecting member 906 and a second arm 908 projecting from the member 906. In this embodiment, the probe is driven so that one of the laterally projecting arms makes contact with an edge of a grinding wheel 910. As shown in the enlarged portion 912 of that figure, the portion of the grinding wheel that does most of the final surface grinding is primarily in the shape of a toroid.

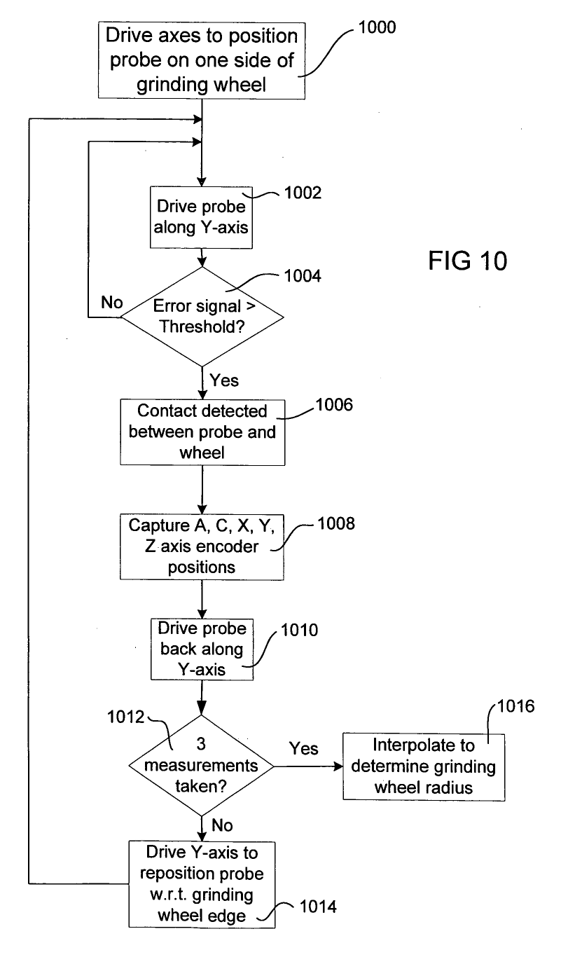

As shown in FIG. 10, the toroidal profile of the grinding wheel can be determined by firstly driving the A, C, X, Y and/or Z axes in step 1000 to position the probe 902 to one side of the grinding wheel. At step 1002, the probe is driven along the Y axis until it is determined at step 1004 that the position error signal in the A or C axis servo control circuit exceeds the predetermined threshold. At this point, contact is determined to have been made between the probe 902 and the grinding wheel 910, at step 106. The axial position data from the encoders or optical scales in the servo mechanisms of the A, C, X. Y and Z axes are then captured at step 1008 and transmitted to the programmable control circuit 222. Once the encoder positions of the A, C, X, Y and Z axes have been captured, the probe is again driven back along the Y-axis in the opposite direction at step 1010 to break contact between the probe and the grinding wheel.

If three measurements have not yet been taken, as determined at step 1012, then the mechanical probe 902 is driven along the C axis at step 1014 so that when the probe is once again driven along the Y axis contact is made at a different position along the profile of the grinding wheel. This process is repeated until a number of measurements (in this example 3) are made. The axial position data from each of the A, C, X, Y and Z axes for each contact point is transmitted to the programmable control unit 222 and, at step 1016, the programmable control unit 222 in circulates between the captured axial position points to determined the grinding wheel toroid radius.

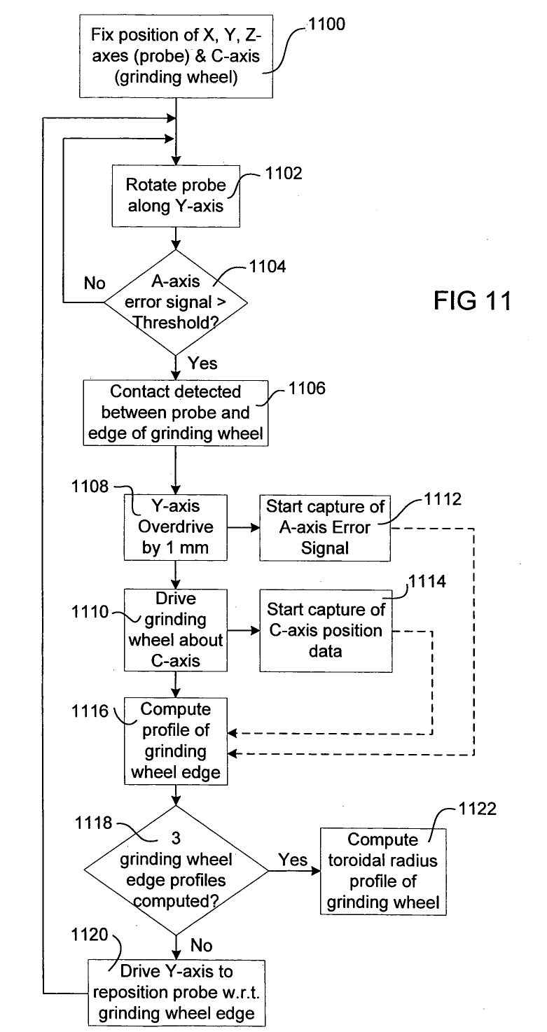

FIG. 11 shows an alternate technique in which, at step 1100, the position of the X, A, Z and C axes are fixed and, at step 1102, the probe 902 is driven along the Y axis. The probe continues to be driven until it is determined at step 1104 that the position error signal in the servo control circuit of the A axis exceeds a predetermined threshold. Contact is then determined at step 1106 to have been made between the contact probe 902 and the edge of the grinding wheel 910. The Y axis is then overdriven at step 1108 by a preloaded amount, typically 1 mm, whilst the grinding wheel 910 is driven about the C axis at step 1110. Whilst the grinding wheel is being driven, both the position error signal in the A axis is captured at step 1112, and the C axis axial position is also captured. As the grinding wheel is driven about the C axis, irregularities in the surface of the grinding wheel will cause the position error signal in the A axis to vary. These variations are representative of the fluctuations in the radial dimension of the grinding wheel around the circumference of the wheel.

At step 1116, the profile of the grinding wheel along the point of contact between the second arm 908 of the probe 902 with the surface of the grinding wheel 910 is computed by the programmable control unit 222. If less than a predetermined number, for example three, of profiles are determined to have been captured at step 1118, then the mechanical probe is repositioned along the C axis at step 1120, and steps 1102 to 1116 repeated. If however three grinding wheel edge profiles have been computed, then the toroidal radius profile of the grinding wheel is computed by the programmable control unit 222 at step 1112.

In the example shown in FIG. 11, it will be appreciated that the position error signal in the servo control circuit is not merely used to detect contact between a mechanical probe and the grinding wheel, but the magnitude of the position error signal is used to develop a profile of the grinding wheel as contact is maintained with the mechanical probe and the edge of the grinding wheel during grinding wheel rotation.

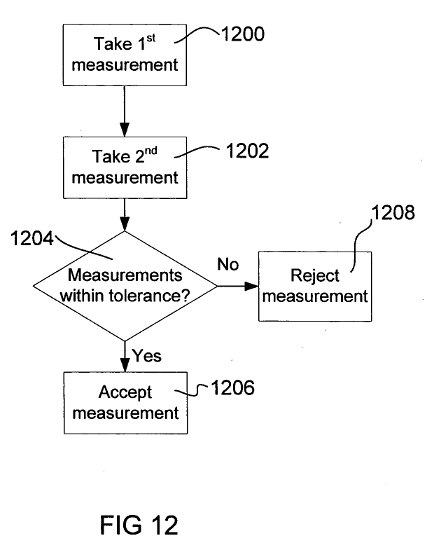

Due to the extremely small movements involved, vibrations can lead to contact inadvertently being made between the mechanical probe and the grinding wheel of a CNC grinding machines. In order to reject such false readings, a two or more consecutive readings may be made, as shown in steps 1200 and 1202 of FIG. 12. If it is determined at step 1204 that the two readings are within tolerance, then the first or second reading—or an average of the two readings—is accepted at step 1206. Otherwise, the readings are rejected at step 1208.

Other similar techniques may be used to reject erroneous measurements being made. For example, since vibration in CNC grinding machines tends to be random, it is possible to carry out a plausibility check or sanity check on the readings made when contact is detected.

Finally, it is to be understood that various modifications and/or additions may be made to the above described embodiments without departing from the ambit of the invention as defined in the claims appended hereto.

1. A method of sensing contact between a first member and a second member in a computer numerical control machine, wherein the position of at least one of the first member and the second member is controlled by one or more servo mechanisms comprising:
causing at least one of the first member and the second member to be driven towards the other;
monitoring an error signal in one of the servo mechanisms; and
detecting when the error signal exceeds a predetermined threshold.

2. A method according to claim 1, wherein the error signal is representative of the position error in one of the servo mechanisms.

3. A method according to claim 1, wherein the computer numerical control machine includes: a first group of one or more servo mechanisms that drive at least one of the first member and the second member towards the other; and a second group of one or more servo mechanisms, wherein the error signal is detected in one of the second group of servo mechanisms.

4. A method according to claim 3, wherein one of the first group of servo mechanisms drive one of the first member and the second member in a circular arc motion.

5. A method according to claim 4, wherein one of the first group of servo mechanisms drive one of the first member and the second member in a linear motion.

6. A method according to claim 1, further comprising:
limiting the directional torque of a servo amplifier forming part of one of the servo mechanisms.

7. A method according to claim 6, wherein the directional torque is limited by setting a servo amplifier directional current limit.

8. A method according to claim 1, wherein the second member is any one of a workpiece, a grinding wheel or a cutting tool.

9. A method according to claim 1, wherein the first member is a mechanical probe.

10. A method according to claim 1 further comprising:
determining one or more dimensions of a working member in a computer numerical control machine by
sensing contact between the first member and the second member at two or more locations on the second member;
capturing first member position data at each location; and deriving one or more dimensions of the second member from the captured first member position data.

11. A method according to claim 10, wherein the first member position data is captured from a feedback mechanism forming part of the one or more servo mechanisms.

12. A method according to claim 1, further comprising:
determining the profile of the second member in a computer numerical control machine by
sensing contact between the first member and the second member, at two or more locations on a surface of the working member;
capturing first member position data at each location; and
interpolating between the captured first member position data to determine the surface profile of the second member.

13. A method according to claim 12, wherein the first member position data is captured from a feedback mechanism forming part of the one or more servo mechanisms.

14. A method according to claim 1, further comprising:
determining the profile of a surface of the second member in a computer numerical control machine by sensing contact between a first member and a second member at a first location on the second member;
causing movement of the first member along a first trajectory across the second member surface;
capturing first member position data during movement of the first member across the second member surface;
capturing surface profile data from the error signal in the servo mechanism; and
determining the second member surface profile from the captured first member position data and surface profile data.

15. A method according to claim 14, the method further including the step of: prior to capturing first member position data and surface profile data, causing the servo mechanism to over travel by a preloaded amount after contact is sensed between the first member and the second member.

16. A multi-axis computer numerical control machine including
one or more servo mechanisms for controlling the position of at least one of a first member and second member; and
numerical control apparatus for controlling operation of the servo mechanisms, the numerical control apparatus and the servo mechanisms including one or more control logic elements that cause at least one of the first member and the second member to be driven towards the other, monitor an error signal in one of the servo mechanisms, and detect when the error signal exceeds a predetermined threshold.

17. A multi-axis computer numerical control machine according to claim 16, wherein the control logic elements include at least one processing unit and associated memory device for storing a series of instructions to cause the processing unit to perform one or more steps of a method according to any one of the preceding claims.

18. A multi-axis computer numerical control machine according to claim 16, wherein the control logic elements include one of more digital signal processing elements.

19. A multi-axis computer numerical control machine according to claim 16, wherein the control logic elements include one or more hardware elements.

20. A multi-axis computer numerical control grinding machine including:
one or more servo mechanisms for controlling the position of at least one of a first member and a second member, the second member being a grinding wheel; and
numerical control apparatus for controlling operation of the servo mechanisms, the numerical control apparatus and the servo mechanisms including one or more control logic elements. that cause at least one of the first member and the second member to be driven towards the other, monitor an error signal in one of the servo mechanisms, and detect when the error signal exceeds a predetermined threshold.
